(19) United States
(12) Patent Application Publication
(10) Pub. No.: US 2002/0103904 A1
(43) Pub. Date: Aug. 1, 2002

(54) Method and apparatus for controlling access to files associated with a virtual server

(76) Inventor: Russel C. Hay, Kirkland, WA (US)

Correspondence Address: PARK, VAUGHAN & FLEMING LLP, 508 SECOND STREET, SUITE 201, DAVIS, CA, 95616, US

(21) Appl. No.: 09/773,848

(22) Filed: Jan. 31, 2001

(51) Int. Cl. G06F 15/16; G06F 15/173

(52) U.S. Cl. 709/225; 709/203

(57) ABSTRACT

One embodiment of the present invention provides a system for controlling access to files within a plurality of virtual servers. Each of these virtual servers operates within a separate virtual environment on a single computing device. In operation, a server computing device first accepts a file access request from a client. Next, the server computing device determines if the file access request originated from within a virtual server. Note that each virtual server operates within a virtual environment that is insulated from other virtual environments associated with other virtual servers. If the file access request originated from within the virtual server, the server computing device determines if the file access request is for a new file. If so, the server computing device assigns an identifier to the new file, wherein the identifier can be used to identify the virtual server that created the file. Finally, the server computing device creates the new file within a storage area associated with the server computing device.

### RELATED APPLICATION

The subject matter of this application is related to the subject matter in a co-pending non-provisional application by the same inventor as the instant application and filed on the same day as the instant application entitled, “METHOD AND APPARATUS FOR FACILITATING VIRTUAL SERVER IDENTIFIERS FOR PROCESSES,” having serial number TO BE ASSIGNED, and filing date TO BE ASSIGNED (Attorney Docket No. M00-273100).

### BACKGROUND

1. Field of the Invention

The present invention relates to controlling access to computer files. More specifically, the present invention relates to a method arid an apparatus for facilitating the association of virtual server identifiers to files within a common file system, thereby allowing file accesses only to the virtual server owning specific files.

2. Related Art

A client of an application service provider (ASP) is typically an owner of an application to be hosted by the ASP. Within the ASP, a server is typically a dedicated computing device that provides service to only one client. However, this can be wasteful of resources if the client does not require the full capabilities of the server.

In some cases, a server can be configured to allow access to many clients. Sharing a server among many clients, however, has potential drawbacks and risks. Many times, a client needs to customize system files to the requirements of the client. However, when many clients share the same system files, customization is not possible because the customization needed for one client may make the system unusable for another client. Additionally, when several clients share files on a single computing system, maintaining privacy is difficult.

In one recent innovation described in the related patent application, “METHOD AND APPARATUS FOR FACILITATING VIRTUAL SERVER IDENTIFIERS FOR PROCESSES,” having serial number TO BE ASSIGNED, and filing date TO BE ASSIGNED (Attorney Docket No. M00-273100) by the same author as the instant application, a system has been devised to allow several clients to share a single computing device while providing each client with full access to a complete computing environment. Using this method provides each client with a virtual environment, wherein a client has complete and independent access to all the functions of a “virtual server.” Associated with each of these virtual servers is a virtual server identifier which is used to allow access to the authorized parts of the operating environment.

While using virtual servers allows many clients to coexist on a single computing device, there are still problems with file allocation and file access. A client of one of the virtual servers can still access another client's files located on the common file system.

What is needed is a method and an apparatus to ensure file security and to establish file quotas for clients of virtual server located on the same computing device.

### SUMMARY

One embodiment of the present invention provides a system for controlling access to files within a plurality of virtual servers. Each of these virtual servers operates within a separate virtual environment on a single computing device. In operation, a server computing device first accepts a file access request from a client. Next, the server computing device determines if the file access request originated from within a virtual server. Note that each virtual server operates within a virtual environment that is insulated from other virtual environments associated with other virtual servers. If the file access request originated from within the virtual server, the server computing device determines if the file access request is for a new file. If so, the server computing device assigns an identifier to the new file, wherein the identifier can be used to identify the virtual server that created the file. Finally, the server computing device creates the new file within a storage area associated with the server computing device.

In one embodiment of the present invention, if the file access request is for an existing file, the server computing device retrieves the identifier assigned to the existing file. Next, the server computing device determines if the identifier is associated with the virtual server that generated the file access request. If the identifier is associated with the virtual server that generated the file access request, the server computing device allows access to take place.

In one embodiment of the present invention, if the file access request is a request to delete the existing file, the server computing device deletes the existing file.

In one embodiment of the present invention, if the file access request is a request to modify the existing file, the server computing device modifies the existing file.

In one embodiment of the present invention, if the file access request is a request to allocate an additional file space, the server computing device first determines if space is remaining in the storage area associated with the server computing device that is available to the virtual server. If space is remaining, the server computing device allocates the additional file space.

In one embodiment of the present invention, the server computing device allows a system administrator to establish an amount of storage within the storage area associated with the server computing device that is available to each virtual server.

In one embodiment of the present invention, if the file access request did not originate from within the virtual server, the server computing device first determines if the file access request is a request to update the virtual server identifier of a file. If the file access request is a request to update the virtual server identifier, the server computing device updates the identifier.

### BRIEF DESCRIPTION OF THE FIGURES

FIG. 1 illustrates computing devices coupled together in accordance with an embodiment of the present invention.

FIG. 2 illustrates file storage area 122 in accordance with an embodiment of the present invention.

FIG. 3 is a flowchart illustrating the process of handling a file access request in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Computing Devices

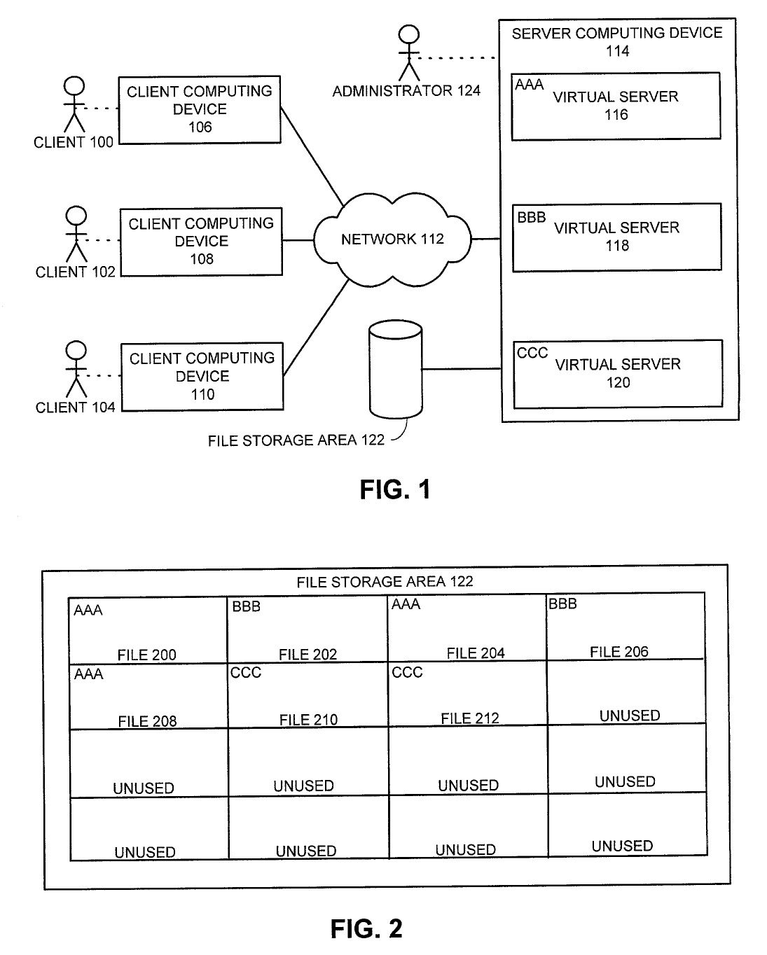

FIG. 1 illustrates computing devices coupled together in accordance with an embodiment of the present invention. The system illustrated in FIG. 1 includes client computing devices 106, 108, and 110 and server computing device 114. Client computing devices 106, 108, and 110 and server computing device 114 can generally include any type of computer system, including, but not limited to, a computer system based on a microprocessor, a mainframe computer, a digital signal processor, a portable computing device, a personal organizer, a device controller, and a computational engine within an appliance. In one embodiment of the present invention, client computing devices 106, 108, and 110 and server computing device 114 are desktop personal computers. In general, the system is not restricted to three client computing devices and may include any number of client computing devices.

Client computing devices 106, 108, and 110 are coupled to server computing device 114 through network 112. Network 112 can generally include any type of wire or wireless communication channel capable of coupling together computing nodes. This includes, but is not limited to, a local area network, a wide area network, or a combination of networks. In one embodiment of the present invention, network 112 includes the Internet.

During operation, clients 100, 102, and 104 use client computing devices 106, 108, and 110 respectively to communicate with server computing device 114 across network 112. Server computing device 114 includes virtual servers 116, 118, and 120. Virtual servers 116, 118, and 120 are assigned to clients 100, 102, and 104 respectively.

Virtual servers 116, 118, and 120 provide the services of an independent server to the clients of virtual servers 116, 118, and 120, including system functions and file storage. Each virtual server operates within a virtual environment that is insulated from other virtual environments associated with other virtual servers. Each virtual server is also assigned an identifier to uniquely identify that server and all files associated with that server. In FIG. 1, virtual server 116 is assigned identifier AAA, virtual server 118 is assigned identifier BBB, and virtual server 120 is assigned identifier CCC.

Administrator 124 administers server computing device 114 by performing a number of tasks including establishing virtual servers 116, 118, and 120, allocating storage space within file storage area 122 for virtual servers 116, 118, and 120, assigning the virtual servers to clients 100, 102, and 104, and establishing a unique identifier for each virtual server.

File storage area 122 is coupled to server computing device 114 and provides a common file storage area for all of the files associated with virtual servers 116, 118, and 120. File storage area 122 provides access control for stored files as described below in conjunction with FIG. 2.

File Storage Area

FIG. 2 illustrates file storage area 122 in accordance with an embodiment of the present invention. File storage area 122 can include any type of non-volatile storage device that can be coupled to a computer system. This includes, but is not limited to, magnetic, optical, and magneto-optical storage devices, as well as storage devices based on flash memory and/or battery-backed up memory.

File storage area 122 provides a common storage area for files associated with virtual servers 116, 118, and 120. As shown, file storage area 122 includes files 200, 202, 204, 206, 208, 210, and 212. The identifier AAA in files 200, 204, and 208 associate these files with virtual server 116. The identifier BBB in files 202 and 206 associate these files with virtual server 118. The identifier CCC in files 210 and 212 associate these files with virtual server 120.

Server computing device 114 uses the identifier within the files to control access to the files and to ensure that a particular client's file storage allocation is not exceeded. When a virtual server, for example virtual server 116, attempts to access a file, server computing device 114 determines if the identifier in the file matches virtual server 116's identifier of AAA. If the identifiers do not match, server computing device 114 prevents access to the file. Server computing device 114 also prevents a virtual server from creating a new file if there is insufficient storage available in the client's allocated space within file storage area 122.

Processing a File Access Request

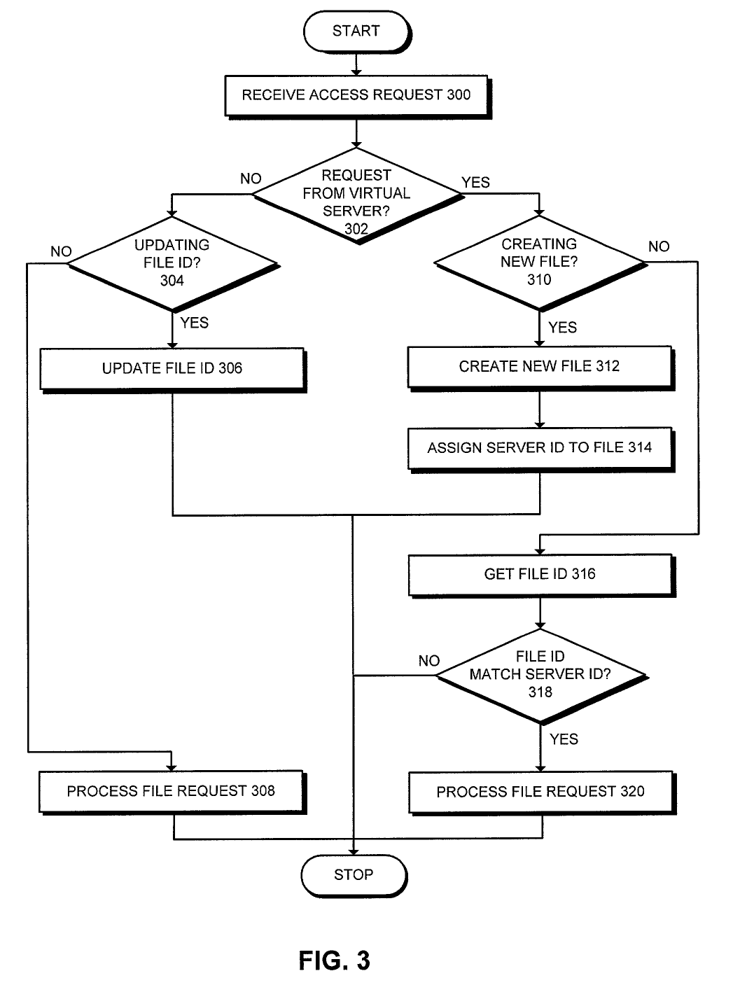

FIG. 3 is a flowchart illustrating the process of handling a file access request in accordance with an embodiment of the present invention. The process starts when server computing device 114 receives a request for a file access (300). Next, server computing device 114 determines if the request is from one of virtual servers 116, 118, or 120 (302). If the request is not from one of virtual servers 116, 118, or 120, the access request originated from administrator 124, and server computing device 114 determines if it is a request to update a file identifier (304).

If the request is a request to update a file identifier, server computing device 114 updates the file identifier (306). Otherwise, server computing device 114 processes the file request and the process is complete (308). Note that administrator 124 has full access to the file system and is allowed to change the identifier for a virtual server as well as for a file.

If the request is from a virtual server at 302, server computing device 114 determines if the request is to create a new file (310). If the request is to create a new file, server computing device 114 creates the new file (312). Next, server computing device 114 assigns the virtual server's identifier to the file and the process is complete (314).

If the request is not to create a new file at 310, server computing device 114 retrieves the file identifier from the file being accessed (316). Next, server computing device 114 determines if the file identifier matches the virtual server's identifier (318). If the file identifier matches the virtual server's identifier, server computing device 114 processes the file request and the process is complete (320).

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for controlling access to files within a plurality of virtual servers, wherein the plurality of virtual servers operate within separate virtual environments on a single computing device, comprising:
accepting a file access request;
determining if the file access request originated from within a virtual server of the plurality of virtual servers, wherein the virtual server operates within a virtual environment that is insulated from other virtual environments associated with other virtual servers;
if the file access request originated from within the virtual server,
determining if the file access request is for a new file; and
if the file access request is for a new file,
assigning an identifier to the new file, wherein the identifier can be used to identify the virtual server, and
creating the new file within a storage area associated with a computing device hosting the plurality of virtual servers.

2. The method of claim 1, wherein if the file access request is for an existing file, the method further comprises:
retrieving the identifier assigned to the existing file;
determining if the identifier is associated with the virtual server that generated the file access request; and
if the identifier is associated with the virtual server that generated the file access request, allowing access to the existing file.

3. The method of claim 2, wherein if the file access request is a request to delete the existing file, the method further comprises deleting the existing file.

4. The method of claim 2, wherein if the file access request is a request to modify the existing file, the method further comprises modifying the existing file.

5. The method of claim 1, wherein if the file access request is a request to allocate additional file space, the method further comprises:
determining if space is remaining in the storage area associated with the computing device that is available to the virtual server; and
if space is remaining in the storage area that is available to the virtual server, allocating the additional file space.

6. The method of claim 1, further comprising allowing a system administrator to establish an amount of storage within the storage area associated with the computing device that is available to the virtual server within the plurality of virtual servers.

7. The method of claim 1, wherein if the file access request did not originate from within the virtual server, the method further comprises:
determining if the file access request is a request to update the identifier; and
if the file access request is a request to update the identifier, updating the identifier.

8. A computer-readable storage medium storing instructions that when executed by a computer cause the computer to perform a method for controlling access to files within a plurality of virtual servers, wherein the plurality of virtual servers operate within separate virtual environments on a single computing device, comprising:
accepting a file access request;
determining if the file access request originated from within a virtual server of the plurality of virtual servers, wherein the virtual server operates within a virtual environment that is insulated from other virtual environments associated with other virtual servers;
if the file access request originated from within the virtual server,
determining if the file access request is for a new file; and
if the file access request is for a new file,
assigning an identifier to the new file, wherein the identifier can be used to identify the virtual server, and
creating the new file within a storage area associated with a computing device hosting the plurality of virtual servers.

9. The computer-readable storage medium of claim 8, wherein if the file access request is for an existing file, the method further comprises:
retrieving the identifier assigned to the existing file;
determining if the identifier is associated with the virtual server that generated the file access request; and
if the identifier is associated with the virtual server that generated the file access request, allowing access to the existing file.

10. The computer-readable storage medium of claim 9, wherein if the file access request is a request to delete the existing file, the method further comprises deleting the existing file.

11. The computer-readable storage medium of claim 9, wherein if the file access request is a request to modify the existing file, the method further comprises modifying the existing file.

12. The computer-readable storage medium of claim 8, wherein if the file access request is a request to allocate additional file space, the method further comprises:
determining if space is remaining in the storage area associated with the computing device that is available to the virtual server; and
if space is remaining in the storage area that is available to the virtual server, allocating the additional file space.

13. The computer-readable storage medium of claim 8, further comprising allowing a system administrator to establish an amount of storage within the storage area that is available to the virtual server within the plurality of virtual servers.

14. The computer-readable storage medium of claim 8, wherein if the file access request did not originate from within the virtual server, the method further comprises:
determining if the file access request is a request to update the identifier; and
if the file access request is a request to update the identifier, updating the identifier.

15. An apparatus that facilitates controlling access to files within a plurality of virtual servers, wherein the plurality of virtual servers operate within separate virtual environments on a single computing device, comprising:
an accepting mechanism that is configured to accept a file access request;
a first determining mechanism that is configured to determine if the file access request originated from within a virtual server of the plurality of virtual servers, wherein the virtual server operates within a virtual environment that is insulated from other virtual environments associated with other virtual servers;
a second determining mechanism that is configured to determine if the file access request is for a new file;
a creating mechanism that is configured to create the new file within a storage area associated with a computing device hosting the plurality of virtual servers if the file request is for a new file; and
an assigning mechanism that is configured to assign an identifier to the new file, wherein the identifier can be used to identify the virtual server.

16. The apparatus of claim 15, further comprising:
a retrieving mechanism that is configured to retrieve the identifier assigned to an existing file;
a third determining mechanism that is configured to determine if the identifier is associated with the virtual server that generated the file access request; and
an accessing mechanism that is configured to allow access to the existing file if the identifier is associated with the virtual server that generated the file.

17. The apparatus of claim 16, further comprising a deleting mechanism that is configured to delete the existing file if the file access request is a request to delete the existing file.

18. The apparatus of claim 16, further comprising a modifying mechanism that is configured to modify the existing file if the file access request is a request to modify the existing file.

19. The apparatus of claim 15, further comprising:
a fourth determining mechanism that is configured to determine if space is remaining in the storage area associated with the computing device that is available to the virtual server; and
an allocating mechanism that is configured to allocate additional space from the storage area.

20. The apparatus of claim 15, further comprising an establishing mechanism that is configured to allow a system administrator to establish an amount of storage within the storage area that is available to the virtual server.

21. The apparatus of claim 15, further comprising:
a fifth determining mechanism that is configured to determine if the file access request is a request to update the identifier; and
an updating mechanism that is configured to update the identifier if the file access request is a request to update the identifier.
